(19) United States
(12) Patent Application Publication
(10) Pub. No.: US 2012/0034039 A1
(43) Pub. Date: Feb. 9, 2012

(54) Landscape Erosion Control Fabric with Mulch Blocking Members

(76) Inventor: Victoria Lynn Hawkins-Maxwell, El Dorado Hills, CA (US)

(21) Appl. No.: 13/206,329

(22) Filed: Aug. 9, 2011

Related U.S. Application Data
(60) Provisional application No. 61/371,943, filed on Aug. 9, 2010.

(51) Int. Cl. E02D 17/20; B29C 43/22

(52) U.S. Cl. 405/302.6; 156/219; 405/302.7

(57) ABSTRACT

Disclosed is a landscape erosion control unit for retaining landscaping materials that includes a base structure and a plurality of retention structures attached to the base structure. Each retention structure of the plurality of retention structures includes a strip and a plurality of protruding members extending outwardly from the strip. Each protruding member of the plurality of protruding members is configured to hold the landscaping materials. Each protruding member of the plurality of protruding members has a bottom portion extending from the strip, a top portion away from the strip, and an intermediate portion between the top portion and the bottom portion. Each retention structure is configured as an integral unit from a material by at least one of cutting and patterning the material. Further, disclosed are a retention structure and a method for fabricating the landscape erosion control unit.

### FIELD OF THE DISCLOSURE

The present disclosure generally relates to erosion control units, and more particularly to landscape erosion control units configured to retain/hold landscaping materials.

### BACKGROUND OF THE DISCLOSURE

Landscaping on a slope presents problems with regard to maintenance thereof due to accessibility issues and erosion of the land area. In general, slopes are often landscaped with a weed control fabric/base fabric to either decrease or eliminate routine maintenance. Further, a landscaping material, such as mulch, is applied on the top of the base fabric for water conservation, weed control, and beautification. Unfortunately, the mulch gradually slides downhill due to wind, and rain and foot traffic, while exposing the base fabric. Thereafter, the base fabric tends to undergo damage due to creation of unsightly bare spots, Ultra Violet (UV) degradation, and fraying.

In order to overcome the above problem, various conventional landscape fabrics and/or landscape erosion control structures/units have been employed to date to provide appropriate landscape erosion control functionality. However, most of the available structures/units are still incapable of effectively retaining the landscaping materials. Further, with the conventional structures/units, it becomes extremely difficult to spread the landscaping materials over the top of a base fabric with a tool (such as a rake) during the initial spreading of the landscaping materials. Furthermore, methods of employing mulch or any other landscaping material may prove to be not cost-effective and labor-intensive as the available structures/units turn out to be ineffective in trapping the landscaping materials. Also, the conventional structures/units are often found to be cumbersome, and accordingly, it becomes difficult to roll, ship, store, and/or install such structures/units.

Accordingly, there is a need for a long lasting and efficient landscape erosion control unit configured to effectively retain landscaping materials, and configured to be easily manufactured, rolled, shipped, stored and/or installed.

### SUMMARY OF THE DISCLOSURE

In view of the foregoing disadvantages inherent in the prior art, the general purpose of the present disclosure is to provide landscape erosion control units, retention structures and a method for fabricating the landscape erosion control units, to include all advantages of the prior art, and to overcome the drawbacks inherent in the prior art.

An object of the present disclosure is to provide an effective, inexpensive, efficient means for appropriately retaining landscaping materials for erosion control.

Another object of the present disclosure is to provide a means that facilitates an easy and reliable spreading of the landscaping materials over a base fabric for erosion control.

Another object of the present disclosure is to provide a light-weight means for erosion control that is easy to roll, ship, store, and/or install over an area of land.

To achieve the above objects, in one aspect, the present disclosure provides a landscape erosion control unit for retaining landscaping materials. The landscape erosion control unit includes a base structure and a plurality of retention structures attached to the base structure. Each retention structure of the plurality of retention structures includes a strip, and a plurality of protruding members extending outwardly from the strip. Each protruding member of the plurality of protruding members is configured to hold the landscaping materials. Further, each protruding member of the plurality of protruding members includes a bottom portion extending from the strip, a top portion away from the strip, and an intermediate portion between the top portion and the bottom portion. Each retention structure is configured as an integral unit from a material by at least one of cutting and patterning the material.

In another aspect, the present disclosure provides a landscape erosion control unit for retaining landscaping materials that includes a base structure and a plurality of retention structures attached to the base structure. Each retention structure of the plurality of retention structures includes at least one strip patterned to form one or more protruding members configured to extend outwardly from the base structure. Each protruding member of the plurality of protruding members is configured to hold the landscaping materials. Each protruding member includes a top portion configured away from the base structure, a bottom portion configured towards the base structure, and an intermediate portion between the top portion and the bottom portion.

In yet another aspect, the present disclosure provides a retention structure for retaining landscaping materials that includes a plurality of protruding members. Each protruding member of the plurality of protruding members is configured to hold the landscaping materials. Each protruding member includes a top portion, a bottom portion adapted to extend from a base structure, and an intermediate portion between the top portion and the bottom portion. Further, each protruding member is formed from a material by at least one of cutting, patterning and bending the material.

In still another aspect, the present disclosure provides a method for fabricating a landscape erosion control unit for retaining landscaping materials. The method includes providing a starting material, and patterning the starting material to configure a retention structure including a plurality of protruding members. Each protruding member of the plurality of protruding members is configured to have a predetermined dimension in order to hold the landscaping materials. Each protruding member further includes a top portion, a bottom portion, and an intermediate portion between the top portion and the bottom portion. The starting material is patterned by at least one of cutting, die cutting, stamping, compressing, bending, bonding, thermo molding, laminating, injection molding and open casting.

These together with the other aspects of the present disclosure, along with the various features of novelty that characterize the present disclosure, are pointed out with particularity in the claims annexed hereto and form a part of the present disclosure. For a better understanding of the present disclosure, its operating advantages, and the specified objects attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will be better understood with reference to the following detailed description and claims taken in conjunction with the accompanying drawings, wherein like elements are identified with like symbols, and in which:

FIG. 1 illustrates a perspective view of a landscape erosion control unit, in accordance with an embodiment of the present disclosure;

FIG. 2 illustrates another perspective partial view of the landscape erosion control unit of FIG. 1;

FIG. 3 illustrates a perspective view of a retention structure of the landscape erosion control unit of FIG. 1, in accordance with an embodiment of the present disclosure;

FIG. 4 illustrates a perspective view of the landscape erosion control unit of FIG. 2 with a frame;

FIGS. 5-11 illustrate different views of a retention structure of the landscape erosion control unit of FIG. 1, in accordance with other embodiments of the present disclosure;

FIG. 12 illustrates a perspective view of a landscape erosion control unit, in accordance with another embodiment of the present disclosure;

FIG. 13 illustrates a front view of two adjacent retention structures of the landscape erosion control unit of FIG. 12, in accordance with an embodiment of the present disclosure;

FIG. 14 illustrates a side view of the landscape erosion control unit of FIG. 12;

FIG. 15 illustrates a front view of a landscape erosion control unit, in accordance with yet another embodiment of the present disclosure;

FIG. 16 illustrates a front view of a retention structure of the landscape erosion control unit of FIG. 15;

FIG. 17 illustrates a front view of the landscape erosion control unit of FIG. 15, in accordance with yet another embodiment of the present disclosure;

FIG. 18 illustrates a front view of a retention structure of the landscape erosion control unit of FIG. 17;

FIG. 19 illustrates a flow chart for a method for fabrication of the landscape erosion control units of FIGS. 1, 12, 15 and 17, in accordance with an embodiment of the present disclosure;

FIG. 20 illustrates a perspective view of a starting material for fabricating the retention structure of FIG. 5, using the method of FIG. 19;

FIG. 21 illustrates a perspective view of an intermediate structure obtained by patterning the starting material of FIG. 20; and

FIGS. 22-29 illustrate intermediate structures patterned from respective starting materials.

Like reference numerals refer to like parts throughout the description of the drawings.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular landscape erosion control unit, a retention structure and a method for fabrication of the landscape erosion control unit, as shown and described. It is understood that various omissions and substitutions of equivalents are contemplated as circumstances may suggest or render expedient, but these are intended to cover the application or embodiments without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. Further, the terms, “a” and “an” herein do not denote a limitation of quantity, but rather denote the presence of at least one of the referenced item. Unless limited otherwise, the terms “attached,” “coupled,” and variations thereof herein are used broadly and encompass direct and indirect attachments and couplings.

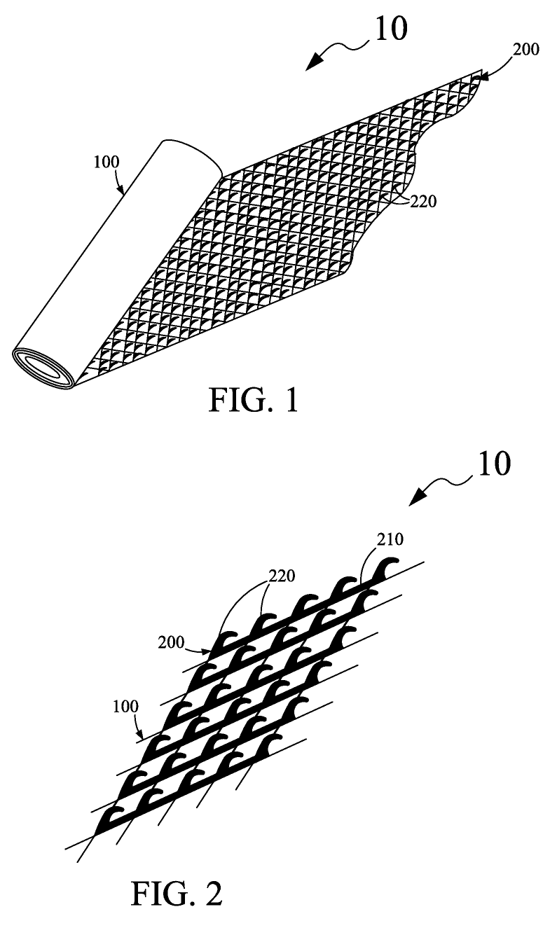

In one aspect, the present disclosure provides a landscape erosion control unit for retaining landscape materials (such as straw and mulch) for erosion control. The landscape erosion control unit is configured to be applied/installed over an area of land, such as a sloped area/site, for erosion control. Various embodiments of the landscape erosion control unit of the present disclosure are provided in FIGS. 1-18.

FIG. 1 depicts a landscape erosion control unit 10 of the present disclosure. The landscape erosion control unit 10 includes a base structure 100. The base structure 100 is a landscape fabric composed of a polymeric material, and more specifically, an open weave mat material (a woven landscape fabric). Alternatively, the base structure 100 may be a non-woven landscape fabric. Also, the base structure 100 may be a rectangular shaped structure provided in the form of a roll. However, the base structure 100 may have any other suitable shape.

Further, the landscape erosion control unit 10 includes a plurality of retention structures 200 attached to the base structure 100, as depicted in FIGS. 1 and 2. Each retention structure of the retention structures 200 is one of fixedly attached and removably attached to the base structure 100. The retention structures 200 may be arranged either in a vertical orientation or a horizontal orientation depending on the orientation of the base structure 100 and dimensions of a sloped area on which the landscape erosion control unit 10 is to be applied.

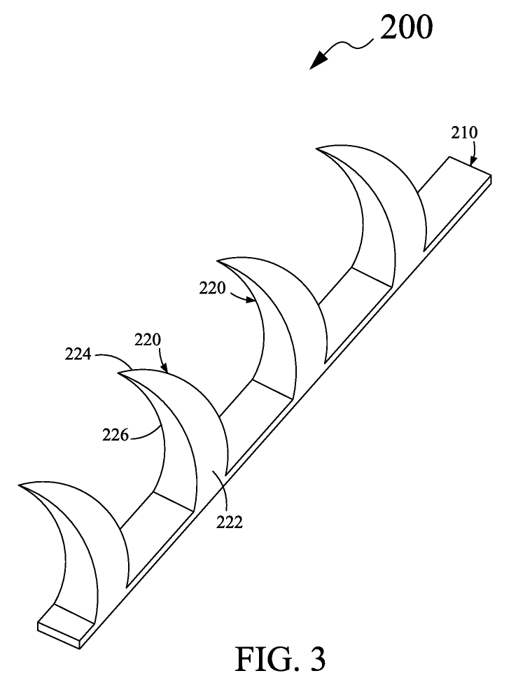

Each retention structure of the retention structures 200 includes a strip 210 and a plurality of protruding members 220 extending outwardly from the strip 210, as depicted in FIGS. 1-3. Each protruding member of the protruding members 220 is configured to hold the landscaping materials. Each protruding member of the protruding members 220 includes a top portion 224 away from the strip 210, a bottom portion 222 extending from the strip 210, and an intermediate portion 226 between the top portion 224 and the bottom portion 222, as depicted in FIG. 3. Each retention structure of the retention structures 200 is configured as an integral unit from a material by at least one of cutting and patterning the material. Further, each retention structure may be composed of a polymeric material. Additionally, the retention structures 200 may have either a black color or any dark color corresponding to the color of the landscaping materials.

Furthermore, each protruding member of the protruding members 220 is configured to have a shape of one of a stud, a triangle, a square, a wave, and a hemisphere. For the purpose of the present disclosure, each protruding member is configured to have a shape of a stud, as depicted in FIGS. 1-3. However, it will be evident that the shape of each protruding member should not be considered as a limitation to the present disclosure. In addition, each protruding member of the protruding members 220 may be inclined at an angle relative to at least one of the strip 210 and the base structure 100. Specifically, each protruding member of the protruding members 220 may be inclined at an angle of about 45 degrees from the base structure 100.

Further, two adjacent protruding members of the protruding members 220 are configured in a manner such that corresponding bottom portions of the two adjacent protruding members are joined together through the strip 210. Specifically, the corresponding bottom portions of the two adjacent protruding members are joined in one of a spaced apart relation and a continuous manner. For the purpose of this description, the corresponding bottom portions of the two adjacent protruding members are joined in a spaced apart relation through the strip 210, as depicted in FIGS. 2 and 3. Specifically, each protruding member may be configured at a distance ranging from about 4.8 centimeters (cm) to about 5 cm from an adjacent protruding member. Further, each protruding member may have a height ranging from about 4 cm to about 4.5 cm, a thickness of about 0.65 millimeters (mm), and a width (base) ranging from about 1.5 cm to about 2 cm. However, the aforementioned shape, dimension, and distance of the protruding members 220 should not be considered as a limitation to the present disclosure. Moreover, the strip 210 is a rectangular strip that may have a width of about 5 mm, and a length of about 100 cm or 1100 mm. However, the aforementioned shape and dimension of the strip 210 should not be considered as a limitation to the present disclosure.

As described above, each retention structure of the retention structures 200 is fabricated while having the strip 210 along with the protruding members 220 as an integral unit. Further, the landscape erosion control unit 10, in its entirety, may also be fabricated as a single integral unit, i.e., the base structure 100 and the retention structures 200 may be configured as an integral unit.

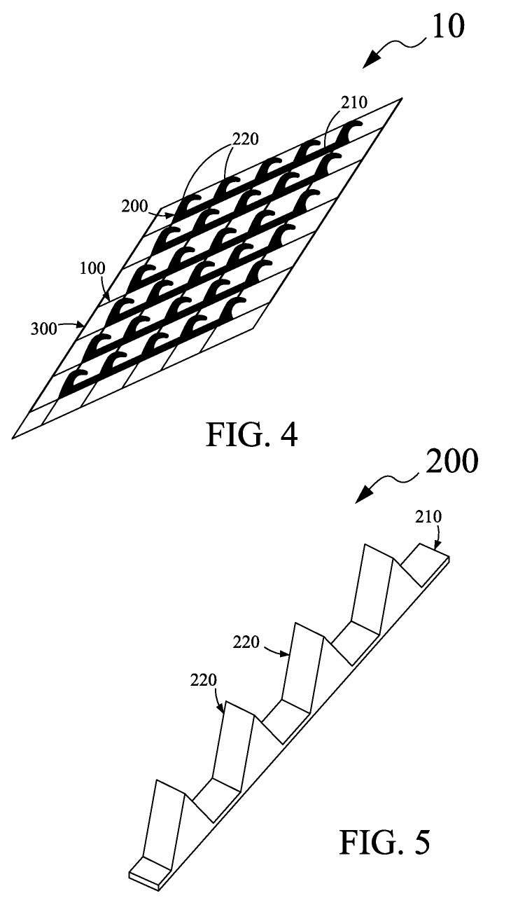

Referring to FIG. 4, the landscape erosion control unit 10 may further include a frame 300 to support the retention structures 200 and to facilitate the attachment of the retention structures 200 to the base structure 100. The frame 300 assists in encasing the retention structures 200 to help hold the retention structures 200 in place during the attachment to the base structure 100. The frame 300 may be applied either manually to the ground or with the help of a machine automated process. The frame 300 is shown to have a specific shape based on the arrangement and dimensions of the retention structures 200. However, the shape and dimension of the frame 300 may vary based on the structural configuration of the landscape erosion control unit 10.

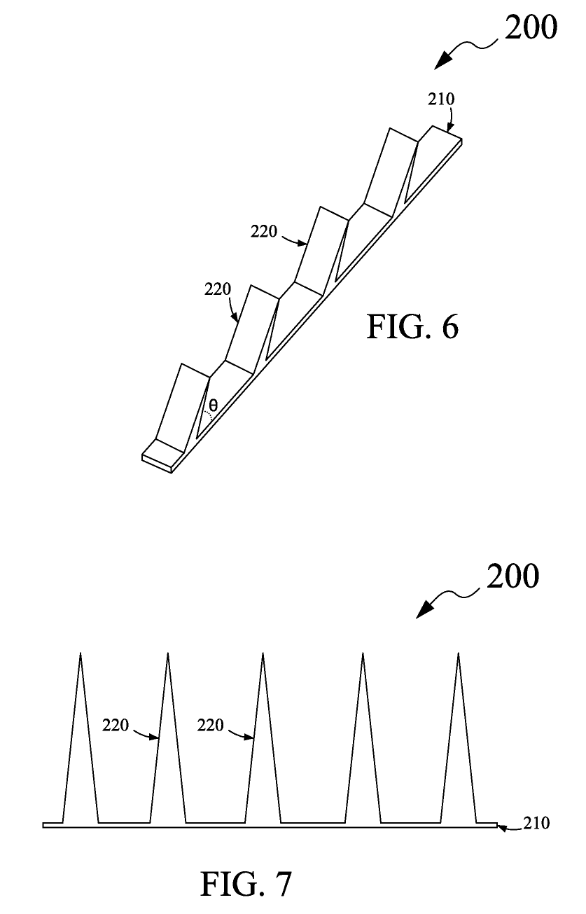

According to another embodiment of the present disclosure, each retention structure of the retention structures 200 is fabricated to have the protruding members 220 with a shape of a triangle, as depicted in FIG. 5. Further, the protruding members 220 may either be configured vertically relative to the strip 210 (as depicted in FIG. 5) or inclined at an angle ‘θ’ (such as an angle of about 45 degrees) relative to the strip 210 (as depicted in FIG. 6). Furthermore, the protruding members 220 may be configured to have an elongated triangular shape, as depicted in FIG. 7.

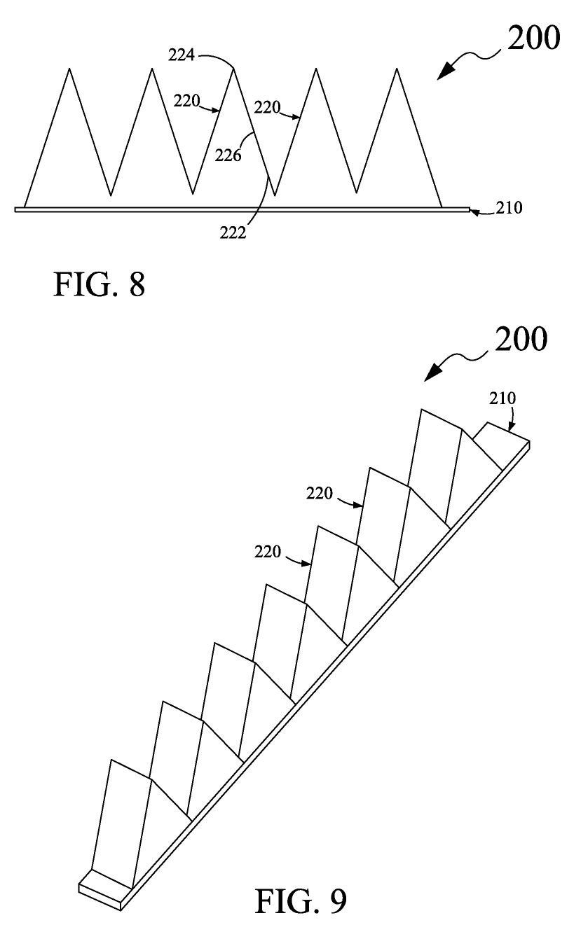

As depicted in FIGS. 5 and 6, the corresponding bottom portions of the two adjacent protruding members of the protruding members 220 are joined together in a spaced apart relation through the strip 210. Alternatively, the corresponding bottom portions of the two adjacent protruding members of the protruding members 220 may be joined together in a continuous manner, as depicted in FIGS. 8 and 9. Further, each protruding member of the protruding members 220 of FIGS. 8 and 9 may have a height ranging from about 4 cm to about 4.5 cm, a thickness ranging from about 0.4 mm to about 0.65 mm, and a width (base) of about 2.4 cm. However, the aforementioned shape and dimension of the protruding members 220 should not be considered as a limitation to the present disclosure. Moreover, the strip 210 (as depicted in FIGS. 8 and 9) is a rectangular strip that may have a width ranging from about 0.5 mm to about 1 mm, and a length of about 110 cm. However, the aforementioned shape and dimension of the strip 210 should not be considered as a limitation to the present disclosure.

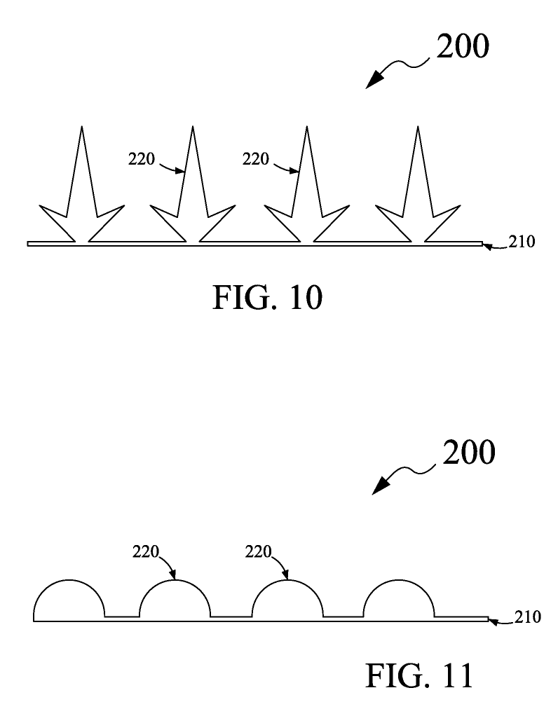

According to yet another embodiment of the present disclosure, the protruding members 220 may be configured to have an irregular shape, as depicted in FIG. 10. Alternatively, the protruding members 220 may be configured to have a shape of a hemisphere, as depicted in FIG. 11. It will be evident that based on the overall shape of each of the protruding members 220, the shape of the bottom portion 222, the top portion 224, and the intermediate portion 226 may vary.

In another aspect, the present disclosure provides a landscape erosion control unit 40 for retaining landscaping materials, as depicted in FIG. 12. The landscape erosion control unit 40 includes a base structure 400 and a plurality of retention structures 500 attached to the base structure 400. Each retention structure of the retention structures 500 is one of fixedly attached and removably attached to the base structure 400. The base structure 400 may be a rectangular shaped structure provided as a roll, and may be composed of a non-woven polymeric material.

Each retention structure of the retention structures 500 includes at least one strip patterned to form one or more protruding members configured to extend outwardly from the base structure 400. For the purpose of this description, each retention structure of the retention structures 500 includes a single strip, such as a strip 510, patterned (by bending) to form a plurality of protruding members 520 configured to extend outwardly from the base structure 400 (as depicted in FIGS. 12-14). Specifically, each protruding member (upside down ‘V’ shaped member) of the protruding members 520 may be attached to the base structure 400 by a means such as welding through each end portions (not numbered) of each protruding member. As depicted in FIG. 12, the symbol ‘W’ depicts welding points that may be either thickened or allowed to have a flat space between adjacent protruding members of the protruding members 520, for easier welding during a manufacturing process. It may be evident that alternate means of attachment may be used for attaching the protruding members 520 onto the base structure 400.

Further, each protruding member of the protruding members 520 is configured to hold the landscaping materials. Furthermore, each protruding member of the protruding members 520 includes a bottom portion (not numbered) configured towards the base structure 400, a top portion (not numbered) configured away from the base structure, and an intermediate portion (not numbered) between the top portion and the bottom portion.

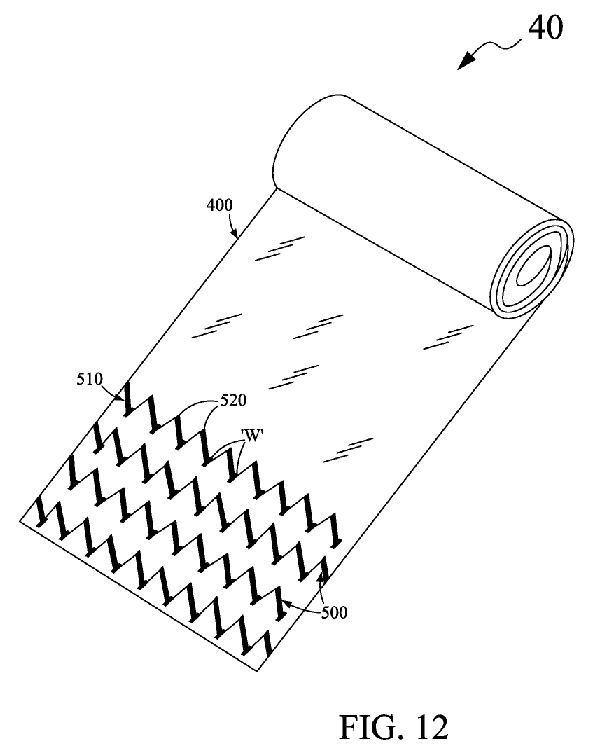

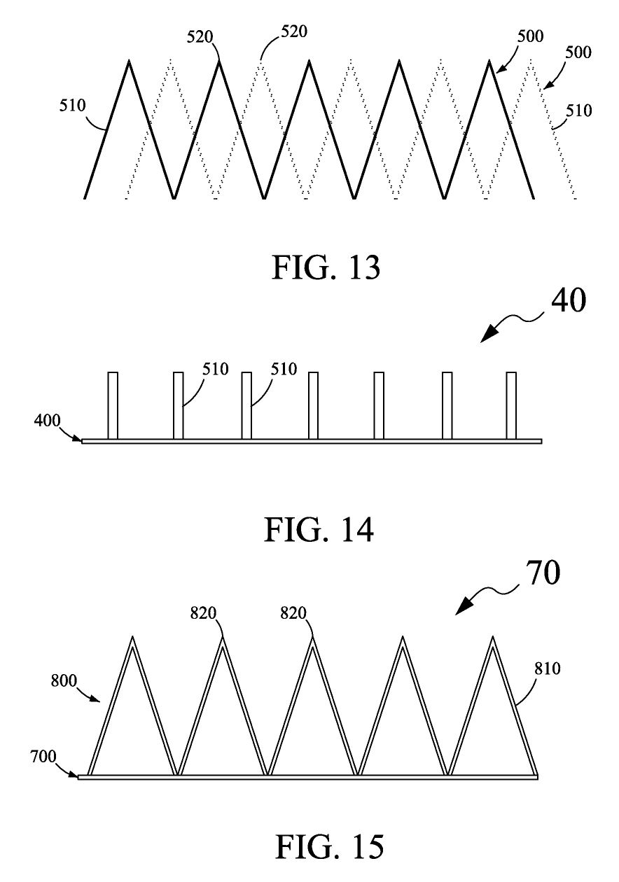

In addition, each protruding member of the protruding members 520 is configured to have a shape of one of a stud, a triangle, a square, a wave, and a hemisphere. For the purpose of the present disclosure, each protruding member is configured to have a shape of a triangle, as depicted in FIGS. 12 and 13, while forming an accordion type structure. However, it will be evident that the shape of each protruding member should not be considered as a limitation to the present disclosure. Also, each protruding member of the protruding members 520 has a height of about 4 cm, and a width (base) of about 2.5 cm. However, the aforementioned dimension of the protruding members 520 should not be considered as a limitation to the present disclosure. Moreover, the strip 510 may have a width ranging from about 4 mm to about 5 mm, a length of about 110,000 cm, and a thickness ranging from about 0.65 mm to about 1 mm However, the aforementioned dimension of the strip 510 should not be considered as a limitation to the present disclosure.

Further, as depicted in FIG. 13, two strips 510 of the landscape erosion control unit 40 are arranged in an overlapping manner (parallel orientation) in order to facilitate appropriate holding of landscaping materials. Specifically, the two strips 510 are shown to be arranged in a parallel orientation wherein a crest (not numbered) of a first strip 510 aligns with a corresponding trough (not numbered) of the adjacent strip 510.

In addition, each protruding member of the protruding members 520 may be inclined at an angle (such as an angle of about 45 degrees) relative to the base structure 400. Further, two adjacent protruding members of the protruding members 520 are configured in a manner such that corresponding bottom portions of the two adjacent protruding members are joined together, as depicted in FIGS. 12 and 13. Specifically, the corresponding bottom portions of the two adjacent protruding members are joined in a continuous manner. Also, the landscape erosion control unit 40 may further include a frame (not shown) to support the retention structures 500 and to facilitate the attachment of the retention structures 500 to the base structure 400.

Further, each retention structure of the retention structures 500 may be composed of a polymeric material. Additionally, the landscape erosion control unit 40 may be fabricated in a manner wherein the base structure 400 and the retention structures 500 are configured as an integral unit.

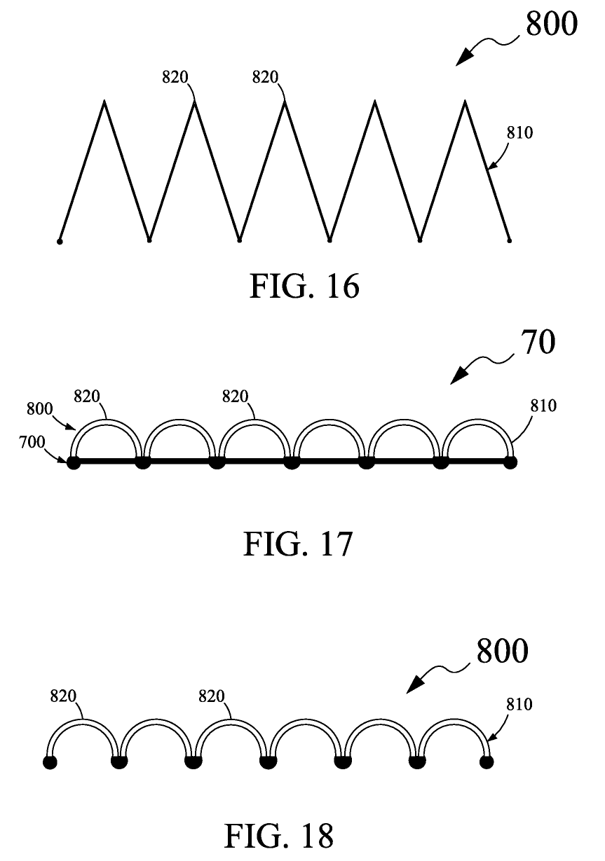

In an alternate embodiment, a landscape erosion control unit 70 of the present disclosure includes a base structure 700 and a plurality of retention structures, such as a retention structure 800, attached to the base structure 700 (as depicted in FIGS. 15 and 16). The retention structure 800 is one of fixedly attached and removably attached to the base structure 700. Further, the retention structure 800 includes more than one strips, and more specifically, a plurality of strips 810. Each strip of the strips 810 is patterned (by bending) to form a protruding member 820 configured to extend outwardly from the base structure 700. For the purpose of this description, the strips 810 are short and thin strips (having a length of about 1100 mm) joined to form the retention structure 800, in such a way that each strip of the strips 810 is patterned to form the protruding member 820 (triangular structure), configured to extend outwardly from the base structure 700.

The protruding member 820 is similar to the protruding members 520, and accordingly, a description thereof is avoided herein for the sake of brevity. In addition, the protruding member 820 is configured to have a shape of a triangle, to facilitate formation of an accordion type structure for the retention structure 800. However, it will be evident that the shape of each protruding member should not be considered as a limitation to the present disclosure. For example, a strip of the strips 810 may be patterned in a manner, such that the protruding member 820 is configured to have a shape of a hemisphere (as depicted in FIGS. 17 and 18).

In still another aspect, the present disclosure provides a retention structure, such as the retention structures 200, 500, and 800, for retaining landscaping materials. As described above in conjunction with FIGS. 1-18, the retention structure includes a plurality of protruding members (such as the protruding members 220, 520, and 820). Further and as described above, each protruding member is formed from a material by at least one of cutting, patterning and bending the material.

In addition, an embodiment of the retention structure (such as the retention structures 200) includes a strip (such as the strip 210) to support the plurality of protruding members thereupon such that each protruding member of the plurality of protruding members extends outwardly from the strip. Further, the strip is configured to be attached to a base structure (such as the base structure 100).

As various embodiments of the retention structure of the present disclosure are already described in conjunction with FIGS. 1-18, a description of the retention structure is avoided herein for the sake of brevity.

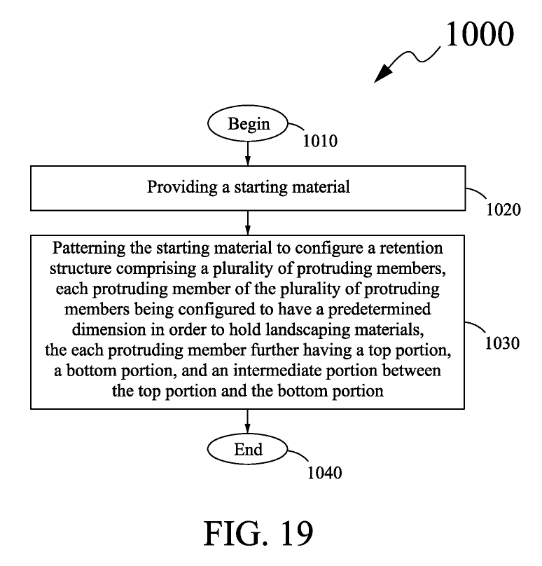

In yet another aspect, the present disclosure provides a method 1000 for fabricating a landscape erosion control unit, such as the landscape erosion control units 10, 40 and 70, for retaining landscaping materials, as depicted in FIG. 19.

The method 1000 begins at 1010. At 1020, a starting material to fabricate a retention structure (such as the retention structures 200, 500 and 800) is provided. The starting material may be a firm and foamed material. A suitable example of the starting material to fabricate the retention structure includes, but is not limited to, a polymeric material, such as a plastic material (for example, polypropylene; polyethylene; and any other combination of plastic including urethane, nylon, silicon, closed-cell foam, open-cell foam, cross-linked foam, foam with skin and other suitable material). Further, the starting material may include an Ultra Violet (UV) inhibitor, such as carbon black being added as a natural UV inhibitor or any other such material capable of increasing shelf-life of the retention structure. Moreover, recycled plastic may be used as the starting material.

The use of a light-weight material such as a foamed plastic helps to reduce the weight of the completed roll once the material is attached to the base structure. Also, the strips fabricated from foamed materials are capable of being arranged either in rolls or configured to have dimensions (width/length) of the base structure. Accordingly, such strips are lighter than a solid form of plastic, depending on either the thickness/design of the finished strip or preferred manufacturing method. It will be evident that use of foam facilitates in providing a tighter roll during shipping.

In addition, the starting material used for retention structures that are required for seeding on open weave netting or used alone on the earth for the purpose of erosion control may be a degradable material to facilitate degradation of the retention structures after sprouting of the seeds and maturing of the plants. Specifically, bio-degradable materials such as wood pulp, vegetable, corn starch, and any such other dissolvable material, may be used for the purpose of the present disclosure.

At 1030, the starting material is patterned to configure the retention structure (such as the retention structures 200, 500, and 800) that includes a plurality of protruding members (such as the protruding members 220, 520, and 820). Each protruding member of the plurality of protruding members is configured to have a predetermined dimension in order to hold the landscaping materials. Further, each protruding member includes a top portion (such as the top portion 224), a bottom portion (such as the bottom portion 222), and an intermediate portion (such as the intermediate portion 226) between the top portion and the bottom portion. Furthermore, two adjacent protruding members of the plurality of protruding members are configured in a manner such that corresponding bottom portions of the two adjacent protruding members are joined together. Specifically, the corresponding bottom portions of the two adjacent protruding members are joined in one of a spaced apart relation and a continuous manner.

The term ‘predetermined dimension’ as used hereinabove and below relates to the dimensions of each protruding member as described in conjunction with FIGS. 1-18.

Patterning of the starting material may be achieved by at least one of cutting, die cutting, stamping, compressing, bending, bonding, thermo molding, laminating, injection molding and open casting. Further, the starting material may be provided in a form being at least one of a sheet, a flat piece, an extruded piece, a pre- extruded piece of the polymeric material, a laminated fabric, and one or more strips. The method 1000 ends at 1040 after patterning the starting material.

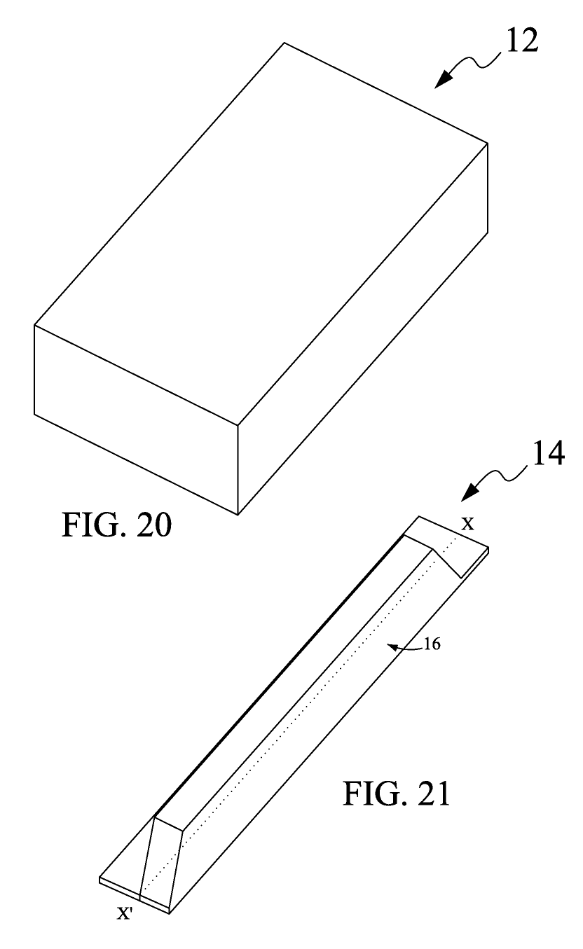

In one embodiment of the method 1000 for fabricating the retention structures 200 of FIG. 5, a starting material such as a material 12 (for example, a foam material) may be provided at step 1020, as depicted in FIG. 20. The material 12 may be either a flat piece or an extruded piece. For the purpose of this description, the material 12 is a flat piece. Thereafter, the material 12 may be patterned by cutting to form an intermediate structure 14, as depicted in FIG. 21. Further, triangular shapes that form the protruding members 220 may be cut from a protruding portion 16 of the intermediate structure 14, and a base that forms the strip 210 may be cut along the line X-X′ of the intermediate structure 14. Furthermore, the desired thickness and height of the protruding members 220 is obtained by patterning the aforementioned cut portions using one or more techniques such as a rotary die cut, stamping, and compressing, to form the triangular/saw tooth pattern as depicted in FIG. 5.

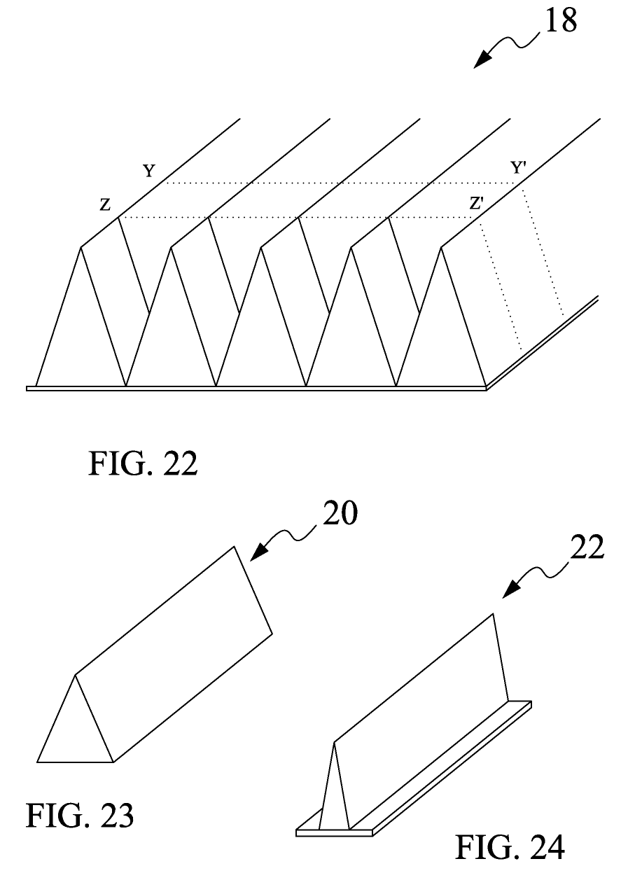

Alternatively, the material 12 (foam material) may be patterned in the form as depicted by a structure 18 (intermediate structure) in FIG. 22. Specifically, FIG. 22 depicts existing foam cut widths along lines Y-Y′ and Z-Z′ to form the triangular/saw tooth pattern as depicted in FIGS. 8 and 9.

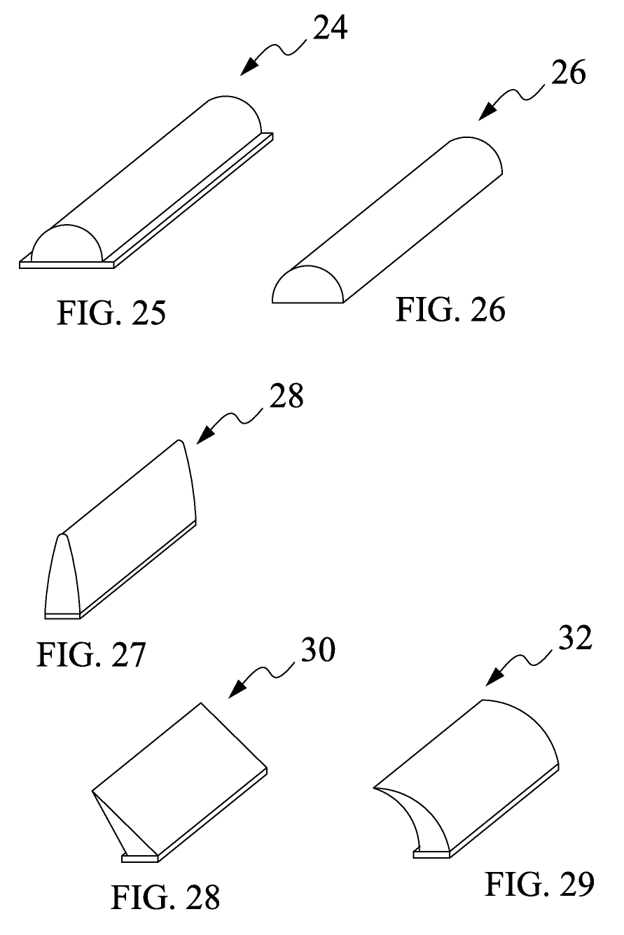

Similarly, various other starting materials (as described above) may be patterned as intermediate structures 20, 22, 24, 26, 28, 30, and 32, as depicted in FIGS. 23-29, in order to form the plurality of protruding members having different shapes (such as shape of a triangle, a hemisphere and the like), for the purpose of this description. More specifically, the starting materials as used may be extruded materials that may be shaped in many ways, such as either a solid or notched/die cut triangle; either a solid or die cut stud/wave; either a solid or notched hemisphere/round/square; and either a hollow or a solid tube, and the like, as depicted in FIGS. 23-29. The purpose of the aforementioned designs is to minimize the erosion of the landscaping materials from sliding downhill or to minimize erosion from wind, water, and foot traffic.

Additionally, one strip/piece of either an extruded or a flat sheet material may be cut into two identical pieces to eliminate waste of material. Accordingly, a starting material may be patterned to form multiple strips, such as the strip 210, and/or multiple retention structures, such as the retention structures 220. Further, die cutting into a predetermined pattern may be achieved with a material such as a flat sheet of ridged, foamed material; and a semi flexible polypropylene/a polyethylene material that may be thermoformed with or without vacuum, or formed with a line and seam welder and bending machine, to create an angle either to the strips or an angle at the base of the plurality of protruding members in order to facilitate the plurality of protruding members to incline at an angle. Providing the plurality of protruding members at an angle relative to at least one of the base structure and the strip assists in trapping the landscape materials effectively. Further, plurality of protruding members acts as a dam structure when each protruding member of the plurality of protruding members is configured as vertical structure (straight-up without any inclination).

For the purpose of this description, the method 1000 further includes attaching the retention structure to a base structure, such as the base structures 100, 400 and 700. Specifically, the plurality of protruding members with the strips may be attached to the base structure during manufacturing as a unit. Accordingly, the strips may be fixedly attached to the base structure. Alternatively, the fabricated strips of the plurality of protruding members may be removably attached to the base structure with stakes at the time of application. Further, the strips may also be provided with an attachment means, such as an adhesive backing with a pull strip (for removable/detachable attachment), that assists in the application of the retention structures and the base structure to the slope. Further, use of the aforementioned attachment reduces the number of stakes required for attachment and the number of stake holes required in the base structure. Furthermore, the use of the aforementioned attachment facilitates greater flexibility in the cost management and greater flexibility of horizontal/vertical spacing of strips.

Based on the aforementioned, the strips 210, 510 and 810 may be attached to the respective base structures 100, 400 and 700, either manually or by a machine. For example, numerous examples of methods of attachment include, but are not limited to, manual stakes (as described above), seam welding, laser joining, mask laser joining, UV ray, and adhesive. Further, spin, ultrasonic friction methods of welding, heat clamping, blister sealing, hot air welding or any other similar process may be used to fuse plastics. Heat welding includes many techniques, such as jaw bars for heat welding and zebra bands that have hot and cold zones for intermittent seals. Additionally, cut and seal machines may be used for both bending plastic and cutting the waste at the same time. The cut and seal machines may also come in double band heating wires. Furthermore, line welding, either open-welding or enclosed, may be used for the purpose of this description. Moreover, longitudinal seam welding may be used for double/multilayer fabric joining. Also, any method of plastic fusion may be employed without departing from the scope of the present disclosure.

In another embodiment of the method 1000 for fabricating the retention structures 200 of FIG. 3, a starting material (such as a plastic) may be allowed to undergo extrusion. Further, the extruded/pre-extruded material may be provided at 1020, and may then be subjected to patterning at 1030 by die cutting while retaining space between adjacent protruding members of the protruding members 220. Accordingly, the method 1000 facilitates lodging of the landscaping materials between the protruding members 220, while diminishing a possible visible ridge when the landscaping material degrades. Further, either the starting material or the retention structures 200 may be coated with either a black color or any dark landscape color to help to prevent a visible ridge. It will be evident that cutting sections out of an extruded piece/pipe in any shape helps to mask the underlying structure but is not mandatory to the function or intent of a retention structure, such as the retention structure 200. Accordingly, manufacturing costs and tooling may be considered and may alter the choice of design for blocking the landscaping materials.

In yet another embodiment of the method 1000 for fabricating retention structures 500 of FIGS. 12-14, a starting material in the form of a long thin strip (straight line pattern), to form the strip 510, of an extruded sheet of a plastic material may be provided at 1020. At 1030, the long thin strip may be patterned by cutting and pre-bending in a triangular/accordion pattern, as depicted in FIGS. 12 and 13, to form the strip 510 and the protruding members 520. As depicted in FIGS. 12 and 13, the protruding members 520 are hollow from therewithin, thereby facilitating appropriate lodging of the landscaping materials/water to flow through the open triangular protruding members 520. The open faced triangular protruding members 520 allow for minimal use of the plastic material, as readily available materials such as extruded flat sheets of High Density Polyethylene (HDPE) and High Density Polypropylene (HDPP) may be used as the starting material. Accordingly, the patterning of the starting material simply requires cutting thereof in a straight line and then bending/crimping of the straight line, thereby lowering manufacturing start up tooling costs as compared to other techniques (such as injection molding and so forth).

Additionally and as described in conjunction with FIGS. 15-18, an open pattern without the accordion bent/crimp may be achieved by attaching multiple thin strips (such as the strips 810) of a plastic material every 1-4 inches across the base structure 700 using any attachment/bonding method as mentioned above. The thinness of the strips 810 of the plastic material assists to mask respective top portions (not numbered) of the strips 810 between applications of new landscaping materials.

Also, when the strips 510 and 810 utilize hollow triangular protruding members 520/hemispherical protruding member 820 that are attached to the respective base structures 400 and 700 at the time of manufacturing, an additional step of cutting the respective top portions (not numbered) of the triangular protruding members 520/hemispherical protruding member 820 may be employed to prevent rake entanglement during application of the landscaping materials.

In yet another embodiment of the method 1000, the starting material may be provided as a sheet of plastic that may be thermo molded into the plurality of protruding members (either thick or thin) along with respective strips (such as the protruding members 220 with the strip 210). Specifically, a large sheet of plastic/plastic foam sheeting material may be subjected to thermo molding, and subsequently, the waste material from thermo molded structures may be removed therefrom by cutting. Accordingly, the retention structure as fabricated using the method 1000 may include a strip to support the plurality of protruding members, such that the each protruding member of the plurality of protruding members extends outwardly from the strip. Therefore, the strip and the plurality of protruding members may be formed as an integral unit for fabricating a landscape erosion control unit (such as the landscape erosion control unit 10).

In another embodiment of the method 1000, the starting material may be a full roll of a landscape fabric (polymeric material) that may be patterned by thermo molding/thermo forming and/or heated, and subsequently, stretched into the landscape erosion control unit having the plurality of protruding members. Thereafter, the thermo formed sheet may be welded to another landscape/base fabric in order to form a double layered unit. Accordingly, the method 1000 may also include patterning the starting material to configure the base structure adapted to carry the plurality of protruding members thereupon for fabricating a landscape erosion control unit (such as the landscape erosion control units 10 and 40).

In still another embodiment of the method 1000, the starting material may be a landscape fabric that may be laminated die cut to form the plurality of protruding members with/without strips, and attached to another landscape fabric. Alternatively, the laminated fabric may be die cut into the plurality of the protruding members that may then be thermo molded to incline at an angle relative to the base structure in order to form pockets to trap the landscaping materials.

In another embodiment of the method 1000, the starting material may be a plastic material that may be either injection molded or open-casted onto the base structure to form the plurality of protruding members with/without the strips, to fabricate a landscape erosion control unit (such as the landscape erosion control units 10, 40 and 70).

For the purpose of the above description, suitable examples of the polymeric material to be used for the base structure (such as the base structures 100, 400 and 700) include, but are not limited to, a polymeric material, such as a commercial grade 3-4 ounce non-woven polypropylene, and other open mesh and lighter-weight weed blocking mesh materials. Further, the base structure may have a color, such as black, brown, and grey to blend with the earth and/or landscaping materials. An open weave mat base structure (such as the base structure 100) may also be used for the purpose of this description. It will be evident that the open web or netting allows for slope seeding to prevent ground erosion of soil. Plurality of protruding members on an open web (mat) is capable of holding the landscaping materials that are used to temporarily cover/protect the seedlings during germination and initial new growth. Once the ground cover is secure, the base structure (matting) and the plurality of retention structures disappear into the growth, thereby adding an additional layer of erosion protection.

The present disclosure provides an effective and efficient landscape erosion control unit (such as the landscape erosion control units 10, 40, and 70) that includes blocking members, i.e., protruding members (such as the protruding members 220, 520, and 820) that minimize the movement of mulch and other landscaping materials placed on a fabric, i.e., base structure (such as the base structures 100, 400, and 700). The structural and functional configuration of the landscape erosion control unit of the present disclosure on hillsides offers a decrease in manufacturing tooling and production, and installation costs. Further, various forms (embodiments described above) of the landscape erosion control unit may be provided considering different degrees/steepness of the sloped site onto which the landscape erosion control unit may be employed. Further, strips (such as the strip 210, 510, and 810) of the landscape erosion control unit may be closely positioned at the steepest portion of the sloped site, and may be positioned in a spaced-apart manner in rows at the flattening portion of the sloped site. Additionally, the landscape erosion control unit is a light-weight means for erosion control and is easy to roll, ship, store, and/or install over the sloped site. Moreover, the landscape erosion control unit of the present disclosure may also be used for forest reclamation to stabilize the slopes before rains wash the slopes away.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A landscape erosion control unit for retaining landscaping materials, the landscape erosion control unit comprising:
a base structure; and
a plurality of retention structures attached to the base structure, each retention structure of the plurality of retention structures comprising at least one strip patterned to form one or more protruding members configured to extend outwardly from the base structure, each protruding member of the plurality of protruding members configured to hold the landscaping materials, each protruding member having a top portion configured away from the base structure, a bottom portion configured towards the base structure, and an intermediate portion between the top portion and the bottom portion.

2. The landscape erosion control unit of claim 1, wherein the base structure is a landscape fabric composed of a polymeric material.

3. The landscape erosion control unit of claim 1, wherein the base structure is one of a woven landscape fabric and a non-woven landscape fabric.

4. The landscape erosion control unit of claim 1, wherein each retention structure is composed of a polymeric material.

5. The landscape erosion control unit of claim 1, wherein each protruding member of the plurality of protruding members is configured to have a shape of one of a stud, a triangle, a square, a wave, and a hemisphere.

6. The landscape erosion control unit of claim 1, wherein each protruding member of the plurality of protruding members is inclined at an angle relative to the base structure.

7. The landscape erosion control unit of claim 1, wherein two adjacent protruding members of the plurality of protruding members are configured in a manner such that corresponding bottom portions of the two adjacent protruding members are joined together.

8. The landscape erosion control unit of claim 1, further comprising a frame to support the plurality of retention structures and to facilitate the attachment of the plurality of retention structures to the base structure.

9. The landscape erosion control unit of claim 1, wherein each retention structure of the plurality of retention structures is one of fixedly attached and removably attached to the base structure.

10. The landscape erosion control unit of claim 1, wherein the base structure and the plurality of retention structures are configured as an integral unit.

11. A method for fabricating a landscape erosion control unit for retaining landscaping materials, the method comprising:
providing a starting material; and
patterning the starting material to configure a retention structure comprising a plurality of protruding members, each protruding member of the plurality of protruding members being configured to have a predetermined dimension in order to hold the landscaping materials, each protruding member further having a top portion, a bottom portion, and an intermediate portion between the top portion and the bottom portion, wherein the polymeric material is patterned by at least one of cutting, die cutting, stamping, compressing, bending, bonding, thermo molding, laminating, injection molding and open casting.

12. The method of claim 11, wherein each protruding member is configured to have a shape of one of a stud, a triangle, a square, a wave, and a hemisphere.

13. The method of claim 11, wherein the starting material is provided in a form being at least one of a sheet, a flat piece, an extruded piece, a pre-extruded piece of the starting material, a laminated fabric, and one or more strips.

14. The method of claim 11, further comprising patterning the starting material to configure a base structure adapted to carry the plurality of protruding members thereupon.

15. The method of claim 11, further comprising attaching the retention structure to a base structure, the base structure comprising a landscape fabric.

16. The method of claim 11, wherein each protruding member of the plurality of protruding members is adapted to be inclined at an angle relative to the base structure.

17. The method of claim 11, wherein the retention structure comprises a strip to support the plurality of protruding members, such that each protruding member of the plurality of protruding members extends outwardly from the strip, wherein the strip and the plurality of protruding members are formed as an integral unit.

18. The method of claim 11, wherein two adjacent protruding members of the plurality of protruding members are configured in a manner such that corresponding bottom portions of the two adjacent protruding members are joined together.

19. The method of claim 11, wherein the corresponding bottom portions of the two adjacent protruding members are joined in one of a spaced apart relation and a continuous manner.
